(19) United States
(12) Patent Application Publication
(10) Pub. No.: US 2016/0136696 A1
(43) Pub. Date: May 19, 2016

(54) Meat and Produce Anti-Contamination Rinsing System

(71) Applicant: Rod Christopherson, Florence, MT (US)

(72) Inventor: Rod Christopherson, Florence, MT (US)

(21) Appl. No.: 14/541,465

(22) Filed: Nov. 14, 2014

(51) Int. Cl. B08B 3/02; A23L 1/00

(52) U.S. Cl. CPC B08B 3/02; A23L 1/00

(57) ABSTRACT

A food washing/rinsing system that provides for the safe washing of foods that prevents the spreading of possible contaminants to nearby areas. The invention allows a user to envelop foods to be washed by providing a closed or semi-closed system utilizing nonpermeable bags, curtains or bowls, which direct rinse water from a faucet or spray nozzle to a sink drain, thereby eliminating inadvertent waste water splash.

### CROSS-REFERENCE TO RELATED APPLICATIONS

This application claims the benefit of U.S. Provisional Application No. 61/905,712, filed Nov. 18, 2013, the disclosure of which is incorporated herein by reference.

### BACKGROUND OF THE INVENTION

(1) Field of the Invention

The present invention relates to a method and apparatus for washing/rinsing food or other items in a system that prevents the spread of any possible contaminants outside of the system. This invention allows food preparers assurance that contaminants from the washed/rinsed foods are not inadvertently spread to other foods or surfaces. This invention can also be utilized as an integrated packaging system of the food itself, which can come directly from the food supplier with the food to be rinsed already in place within the bag.

(2) Background

Many potential sources of contaminants exist in foods, especially meats such as chickens, turkeys and other bird species, as well as fruits and vegetables. Salmonella, E. coli and Listeria are examples of such contaminants. Many food preparers desire to wash or rinse those foods prior to their preparation. However, standard washing/rinsing techniques run the risk of inadvertently spreading possible contaminants due to waste water splashing and spreading to other surfaces or foods in the food preparation area, creating a risk of cross-contamination.

### SUMMARY OF THE INVENTION

It is an objective of the present invention to provide an easy to use, disposable or nondisposable, food rinsing/washing system that prevents spreading possible contaminants by sealing the top of the system around a faucet or side spray nozzle, and discharging the waste water directly into a sink drain.

One embodiment of the invention comprises a clear, food-grade, non-permeable, plastic bag of sufficient size to envelop the items being washed and having a top opening of sufficient size to snugly fit around a sink faucet or flexible pull out spray nozzle, and a faucet adapter disc that is placed under the bag and secures onto the faucet or nozzle creating a shower curtain effect within the bag, and said bag having a bottom opening of sufficient size to envelop a colander or other bowl for discharge into a sink drain.

Another embodiment of the invention comprises a clear, food-grade, non-permeable, plastic bag with a top opening where foods to be washed are inserted into the bag. The top has a closing, sealing and securing means to attach to a faucet, or pull out spray nozzle. For example, the top could have an expandable opening that has an adhesive strip that both closes and seals the bag around the faucet. The securing and sealing means could also utilize self sealing stretchable tape. The expandable opening could utilize any common closing means, such as a drawstring, Velcro® , or simply be closed through the use of the securing and sealing means discussed above. The bottom of the bag is secured to a funneling means to ensure the waste water discharges directly into the sink drain. One example is having the bottom of the bag attached to a circular adhesive ring that seals the bottom of the bag to the sink drain, thereby only allowing waste water to pass directly into the drain. The food or other items can then be washed without having any of the waste water go anywhere other than directly into the sewage system.

Another embodiment of the invention utilizes a clear plastic bag that has a rough texture on the inner side of the bag. Examples of the rough texture could be ribbing or protruding nodules. This aspect of the embodiment gives the user greater ability to effectively scrub the food being washed.

Yet another embodiment of the invention is directed to smaller sized foods, such as fruits and vegetables, which utilizes draining/straining holes that are integrated in either the top of the funneling means or at the bottom of the plastic bag attached to the funneling means, that prevents the foods or other items from entering into the sink drain.

Another embodiment is the invention without a top securing/sealing means and without a bottom sealing/securing means, wherein the nonpermeable bag has a top opening of sufficient size to place the food to be washed, and a tapered bottom opening that can be placed within the sink for direct waste water discharge. The user, if desired, could use one hand to wrap the top opening around a faucet to eliminate splash.

An additional embodiment of the invention utilizes a rigid bowl made from suitable materials such as plastics, ceramics, or metal, which has an integrated drain insert that is placed in the drain basin, thereby allowing waste water discharge directly into the drain. The bowl receives the foods to be washed. A nonpermeable bag, or curtain, having a bottom opening with a circumference approximately the same as that of the rim of the bowl, is attached to the bowl at or near the rim of the bowl through an attachment means. The nonpermeable bag or curtain further encloses the food or other items and has a top opening that can be attached to the faucet as described in previous embodiments. Instead of using the bag, a rigid bowl cap with one or more openings can be mated to the bottom bowl. These embodiments also can utilize a removable screen above the drain insert to prevent smaller foods from entering the drain, and can also utilize a removable poultry post to secure the poultry to the bowl.

### BRIEF DESCRIPTION OF THE DRAWINGS

FIG. 1 is a perspective view of the system constructed in accordance with the present invention showing a raw chicken within the bag, and showing the faucet closing and sealing means, as well as the funneling means to direct the discharge water into the sink drain.

FIG. 2 is a close-up drawing showing how the funneling means is positioned in the sink drain to ensure direct discharge into the sewage system.

FIG. 3 shows the funneling means with a barrier comprising of drainage holes to prevent smaller food items from entering into the sink drain.

FIG. 4 shows the side view of one embodiment of the invention that utilizes a rigid, reusable bowl with an integrated drain basin insert. It shows the bag/curtain that is attached the bowl with the bag/curtain secured to a faucet, thereby sealing the system and only allowing waste water to discharge directly into the drain.

FIG. 5 shows view of the in integrated drain basin insert, having a removable screen and having integrated poultry post holders, which secures a detachable poultry post or the removable screen.

FIG. 6 shows a securing means between the bowl and the bag which comprises of a ring/lid that mates with the rim of the bowl. With the bag inside the ring, but over and around the rim, securing the lid will secure and seal the bag to the bowl.

FIG. 7 shows a rigid inverted bowl cap that has openings for the rinse water means.

FIG. 8 shows the system utilizing the rigid bowl cap.

FIG. 9 shows a faucet adaptor disc that is made from semi-rigid food grade plastic having an inner slotted opening that allows the adapter disc to go over and be secured to a faucet or nozzle, but under the rinsing bag, thereby creating a shower curtain effect to facilitate the rinsing action.

### DETAILED DESCRIPTION OF THE PREFERRED EMBODIMENTS

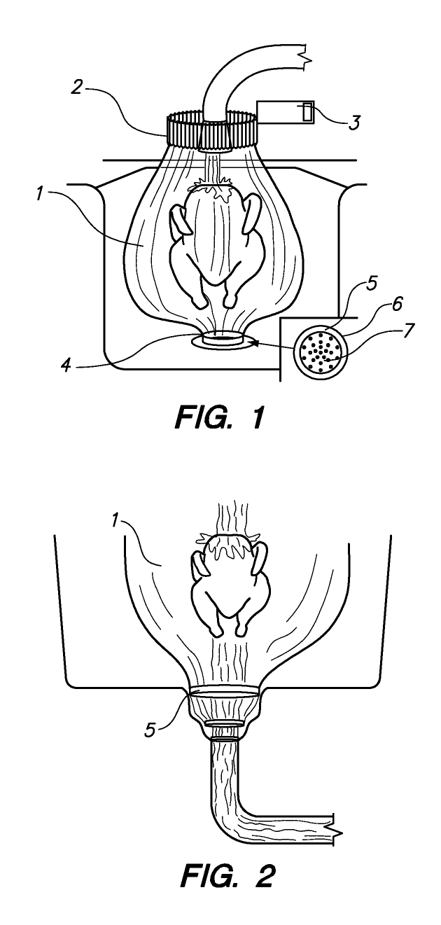

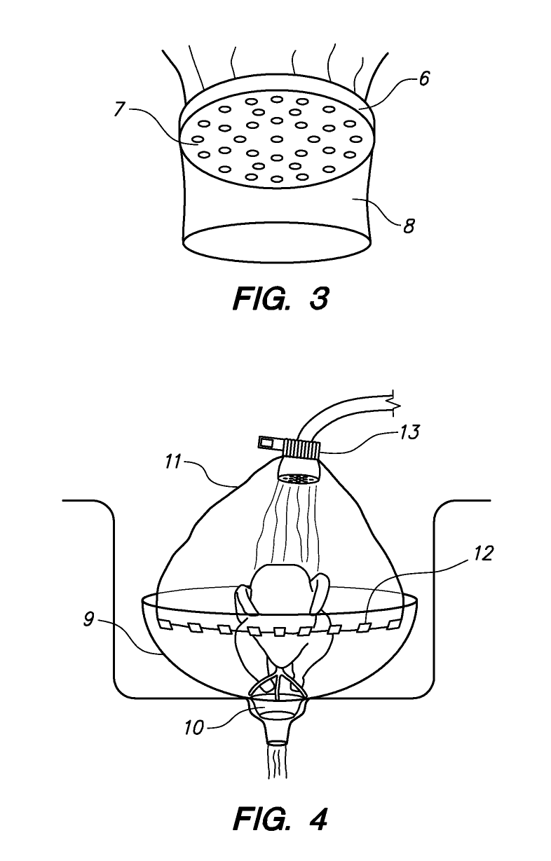

A food washing system is shown generally in FIGS. 1, 2 and 3. A food grade, nonpermeable plastic bag, sized for different foods 1, that has an expandable top opening 2, that is attached to, or made part of the bag 1, and a closing and sealing means 3 for securement and sealing around a faucet or other rinse water means such a faucet spray hose. A funneling means 4 that is connected to the bottom of the bag 1, that permits the waste water to discharge directly into the sink drain. The funneling means comprising a rigid circular ring 5 with an adhesive outer surface 6 for sealing and securing the funneling means within a sink drain. For smaller foods, a drainage barrier having drain holes 7 is integrated into the funneling means to prevent foods from discharging into the sink drain. A portion of the bag 8 may protrude though the bottom of the funneling means to further ensure that the waste water flows directly into the sink drain.

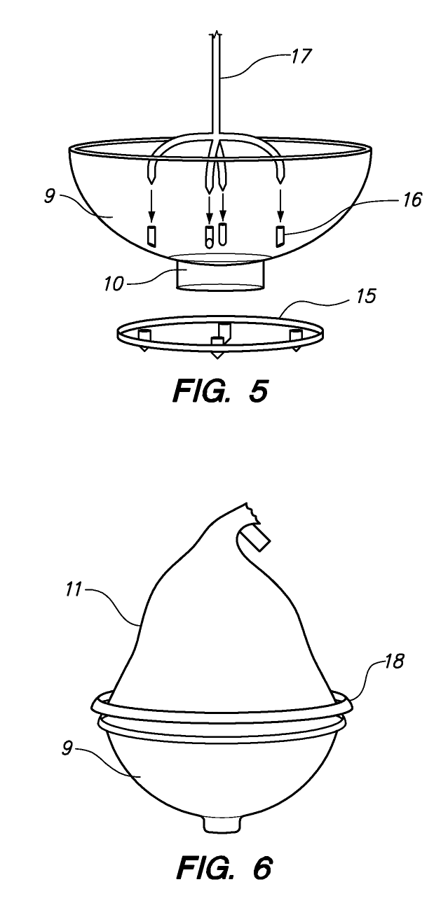

Another embodiment of the invention is shown in FIGS. 4, 5, and 6. A rigid bowl 9 suitably sized for a variety of foods and for placement within a sink, having an integrated drain basin insert 10. A transparent nonpermeable plastic bag 11 having a bottom opening that is secured to the bowl at the bowl rim, or within the bowl, through securing means 12. The top of the bag having a closing, sealing and securing means 13 to secure the top of the system to a faucet. FIG. 5 showing the drain basin insert 10 at the bottom of the bowl 9, further showing a removable screen 15 covering the drain basin insert 10 and having poultry post holders 16 secured to, or integrated into the inside of the bowl, and further showing the removable rigid poultry post 17 having legs that are inserted and secured to the poultry post holders 16. FIG. 6 showing the bag/bowl securing means 12, by utilizing a ring/lid 18 that seals the bag 11 to the bowl 9 by placing the bottom opening of the bag 11 around the rim of the bowl and then securing the ring/lid to the bowl by pressing the ring/lid over the rim thereby sealing and securing the bag to the bowl.

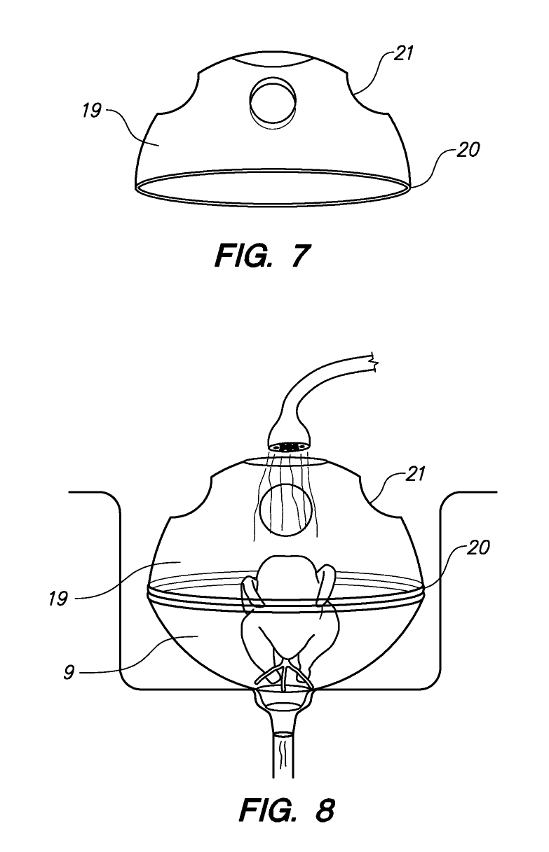

Another embodiment of the invention is shown in FIGS. 7 and 8. Instead of using the nonpermeable bag 11, a rigid inverted bowl cap 19 is secured to the bowl 9 by connecting the rims of each through a securing means 20. Additionally the bowl cap has an opening, or several openings 21, where the faucet or side hose can be placed to rinse the food in different locations.

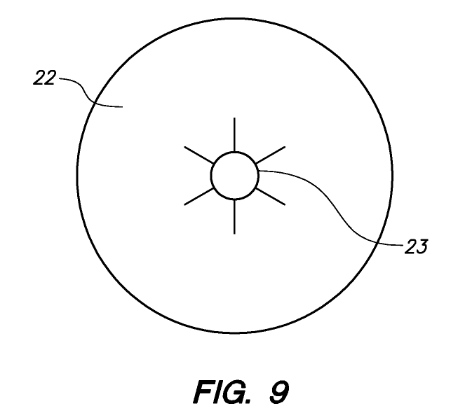

FIG. 9 shows a faucet adaptor disc 22 that is made from semi-rigid food grade plastic having an inner slotted opening 23 that allows the adapter to go over and be secured to a faucet or nozzle head, but under the rinsing bag, thereby creating a shower curtain effect to facilitate the rinsing action.

The present invention has been described with reference to several implementations; however those skilled in the art may recognize that changes may be made without deviating from the scope of the present invention.

I claim:

1. A food washing/rinsing system that prevents possible cross-contamination comprising:
a nonpermeable bag, suitably sized for different foods or other items, having a top opening and a bottom opening.

2. The food washing/rinsing system according to claim 1, wherein the top opening is of sufficient size to snugly fit over a faucet or spray nozzle, and further comprising a faucet adapter disc for placement under the bag and over the faucet or spray nozzle, wherein the faucet adapter disc has an outer diameter of a size that fits within the diameter of the nonpermeable bag, and further having a center hole with a plurality of slots cut outwardly into the faucet adapter disc, thereby allowing the facet adapter disc to go over and be secured to a faucet or spray nozzle.

3. The food washing/rinsing system according to claim 1, wherein the bottom opening is tapered to a diameter smaller than the inner diameter of a sink drain for direct waste water discharge into the sink drain.

4. The food washing/rinsing system according to claim 1, wherein a closing and sealing means is attached to, or made part of, the top opening, which closes the top opening around a faucet or spray nozzle, and both secures and seals the top opening to the faucet or spray nozzle to prevent waste water escape.

5. The food washing/rinsing system according to claim 1, wherein a funneling means is attached to, or made part of the bottom opening, that directs waste water directly into a sink drain, and further may be secured to the sink drain through a connection means.

6. The food washing/rinsing system according to claim 5, wherein the funneling means is comprised of a rigid ring that fits within a sink drain and has an adhesive outer surface to secure the funneling means to the inner surface of the sink drain.

7. The food washing/rinsing system according to claim 5 that has a gasket secured around the funneling means that allows the funneling means to cover and seal the sink drain.

8. The food washing/rinsing system according to claim 7, wherein the gasket has an adhesive on the bottom surface to further aid in the attaching to and sealing over the sink drain.

9. The food washing/rinsing system according to claim 5, having a plurality of drainage holes integrated into funneling means to prevent foods from entering into the sink drain.

10. The food washing/rinsing system according to claim 1, wherein the inner surface of the bag has a rough texture to allow improved scrubbing of the food being washed.

11. A food washing/rinsing system that prevents possible cross-contamination comprising:
a rigid bowl, suitably sized for different foods and for placement within a sink and having an integrated drain basin insert with a bottom opening for placement into a sink drain,
a non permeable bag having a bottom opening of sufficient size to attach to, or near, the rim of the bowl through a securing means, and having a tapered top opening for placement around a faucet or other rinsing means.

12. The food washing/rinsing system according to claim 11, further comprising a gasket placed around the drain basin insert that seals the rigid bowl over the sink drain.

13. The food washing/rinsing system according to claim 11, wherein poultry post holders are secured to, or molded into, the inner surface of said rigid bowl.

14. The food washing/rinsing system according to claim 13, further comprising a detachable poultry post having legs for insertion into the poultry post holders.

15. The food washing/rinsing system according to claim 14, further comprising a removable screen that can be fastened to the poultry post holders through integrated legs when the poultry post is removed.

16. The food washing/rinsing system according to claim 11, further comprising a circular ring/ lid that mates to the rim of the bowl to function as the bag/bowl securing means.

17. A food washing/rinsing system that prevents possible cross-contamination comprising:
a rigid bowl, suitably sized for different foods and for placement within a sink, and having an integrated drain basin insert with a bottom opening for placement into a sink drain,
a rigid bowl cap having a bottom rim sized to mate with the rim of the bowl through a securing means, and further having at least one opening allowing for entry of the rinse water means.

18. The food washing/rinsing system according to claim 17, further comprising a gasket placed around the drain basin insert that seals the rigid bowl over the sink drain.

19. The food washing/rinsing system according to claim 18, wherein poultry post holders are secured to, or molded into, the inner surface of said rigid bowl.

20. The food washing/rinsing system according to claim 19, further comprising a detachable poultry post with integrated legs for insertion into the poultry post holders.

21. The food washing/rinsing system according to claim 20 further comprising a removable screen that can be fastened to the poultry post holders through integrated legs when the poultry post is removed.

22. The food washing/rinsing system according to claim 17, wherein the rigid bowl cap's openings have closing means to close and seal the openings when not in use to prevent spray from leaving the system.
